(19) United States
(12) Patent Application Publication
(10) Pub. No.: US 2006/0288601 A1
(43) Pub. Date: Dec. 28, 2006

(54) Web-guiding device

(76) Inventors: Roland Mayer, Heidenheim (DE); Ingo Gottwald, Zoshingen (DE); Dennis Partheymuller, Nordlingen (DE)

Correspondence Address: VOITH FABRICS, 3040 BLACK CREEK ROAD, P.O. BOX 1411, WILSON, NC, 27893, US

(21) Appl. No.: 10/569,517

(22) PCT Filed: Jun. 14, 2004
(86) PCT No.: PCT/EP04/51099

§ 371 Date: Feb. 24, 2006

(30) Foreign Application Priority Data
Aug. 26, 2003 (DE) 10339262.9

(51) Int. Cl. F26B 19/00

(52) U.S. Cl. 34/71

(57) ABSTRACT

The invention relates to a web-guiding device comprising at least one directing element (10) for guiding a web in a contactless manner in a machine that is used for producing and/or treating a moved web of material (1), especially a paper or cardboard web. Said directing element (10) is provided with a directing surface (12) that is made at least in part of air-permeable porous material (14) which can be impinged upon by compressed air so as to form an air cushion (18) between the directing surface (12) and the moved web of material (1) via the air (16) flowing through said porous material (14). The directing surface (12) is divided into at least one web transfer zone (2, 4) and a web-guiding zone (3) along the direction of movement (2) of the web of material. Said zones (2, 4; 3) are embodied so as to allow for a different air throughput.

### CROSS-REFERENCE TO RELATED APPLICATIONS

The present application is a U.S. National Stage of International Patent Application No. PCT/EP2004/051099 filed Jun. 14, 2004, and claims priority of German Patent Application No. 103 39 262.9 filed on Aug. 26, 2003.

### BACKGROUND OF INVENTION

1. Field of the Invention

The invention relates to a web-guiding device comprising at least one guide element for non-contact web guidance in a machine used for producing and/or treating a moving material web, in particular a paper or board web. It relates further to a machine for producing and/or treating a material web, in particular a paper or board web, comprising at least one such web-guiding device.

2. Discussion of Background Information

In the past, the material web has been guided by means of guide rolls, in which contact with the surface and a drive are absolutely necessary. Such web guidance is, however, relatively complicated and expensive. The web has to be pulled off the surface of such guide rolls, for which purpose appropriate pulling-off forces have to be applied.

Additionally, the material web has been led over an airturn. In this case, although non-contact guidance with a stationary guide element is possible, as a rule a nonuniform pressure prevails in the air cushion. In the event of holes or partial breaks, the web can therefore nevertheless contact the guide element. In addition, no reliable, flat and crease-free web guidance is ensured. For example, it is possible in particular for omega creases, as they are known, to occur. Corresponding web guidance is again known to be expensive. Large quantities of air and large dimensions are necessary.

An airturn, as it is known, normally has slot nozzles with a mutual slot nozzle spacing of about 20 to about 200 mm and a respective slot width which is greater than 1 mm. If rows of nozzle holes are provided, the nozzle hole diameter is generally greater than 2 mm. The web spacing from the surface is generally greater than 5 mm, normally lying in a range from 7 to 20 mm. The pilot pressure in the airturn is generally in a range from 1 to 6 kPa (=0.06 bar). The specific volume flow is normally in a range from 1000 to 30,000 Nm³/h·m².

### SUMMARY OF THE INVENTION

Therefore, the instant invention provides an improved web-guiding device of the type mentioned at the beginning in which the aforementioned disadvantages are eliminated. In particular, stable, crease-free and reliable non-contact web guidance is intended to be achieved. It is intended in particular for use in paper machines, coating machines, calenders, slitter-rewinders and so on to be possible.

According to the invention, the object is achieved in that the guide element has a guide surface which is at least partly composed of an air-permeable porous material to which compressed air is applied, in order via the air flowing through this porous material to form an air cushion between the guide surface and the moving material web, and in that the guide surface is divided along the direction of movement of the material web into at least one web transition zone and one web-guiding zone, which are designed for a different air throughput.

The high pressure loss at the porous material produces a very uniform air cushion, so that the material web is guided reliably at a relatively small distance from the surface. This is associated in particular with a crease-free run. The relatively high internal pressure prevents any web contact with the surface.

The web-guiding device can therefore in particular comprise at least one guide element, which is supplied with compressed air and has an open surface but with a high pressure loss, through which air is forced from the interior. Therefore, in terms of both time and space, a stable uniform air cushion is produced, which guides the web, for example, in a paper machine, a coating machine, a calender, a slitter-rewinder and so on, without contact with the guide element.

Here, provision is made for the part of the guide surface to which compressed air is applied to be subdivided into at least one web transition zone and one web-guiding zone. The web transition zone is a region which is limited with respect to the direction of movement of the material web about the geometric point on the guide surface at which the material web runs on or runs off. The web-guiding zone extends in or counter to the direction of movement adjacent to the web transition zone, and it is used for the actual air-cushioned guidance of the material web. Both the at least one web transition zone and the web-guiding zone have compressed air applied to them but a different air throughput being provided for the different zones.

Since the air cushion explained is produced along the web transfer zone because of a different air throughput than along the web-guiding zone, firstly, at the point on the guide surface at which the material web runs on and/or off, the air cushion can be maintained in a stable manner, although in this zone the slot formed by the material web and the guide surface enlarges and, consequently, air can escape from the web-guiding zone in this region. In other words, the air cushion is kept stable even in its edge region, so the material web does not undesirably come into contact with the guide surface, even at the point at which it runs on and runs off.

Secondly, this non-contact web guidance does not require any specifically increased consumption of compressed air, since a modified air throughput has to be provided only for the web transition zone, that is to say for the surroundings of the point on the guide surface at which the web runs on and runs off. The web-guiding zone, on the other hand, can be supplied with an air throughput which is different from this and suitable to form the air cushion. This makes it possible for the thickness of the air cushion which is formed between the guide surface and the moving material web to be stabilized to a value of, for example, less than 5 mm, in particular less than 3 mm.

In particular, a higher air throughput can be provided in the web transition zone than along the web-guiding zone. An increased air throughput in the web transition zone can prevent undesired contact between the material web and the guide surface particularly effectively if, because of the escape of compressed air in the edge region of the air cushion formed, there is a particularly increased risk of such contact.

The aforementioned web transition zone is preferably a web run-on zone, that is to say a region in the vicinity of the geometric point at which the material web runs onto the guide surface, since in this region the avoidance of undesired contact between the material web and the guide element is particularly important. As an alternative to this, however, the web transition zone can be provided as a web run-off zone only in the region of the point at which the material web runs off.

As an alternative to this, it is possible for the guide surface to have at least two web transition zones, namely at least one web run-on zone and one web run-off zone, between which—relative to the direction of movement of the material web—the web-guiding zone is arranged. In this case, both web transition zones have a different air throughput, in particular a higher air throughput, than the web-guiding zone. In this case, it is possible for the web run-on zone and the web run-off zone to be designed for a different air throughput relative to each other as well, which is in particular in each case higher than the air throughput provided along the web-guiding zone.

The different air throughput can be implemented by the porosity of the web transition zone or a plurality of web transition zones, on the one hand, and the porosity of the web-guiding zone, on the other hand, being different. For instance, the web transition zone can have a higher porosity than the web-guiding zone, in order to implement a higher air throughput in the web transition zone. In particular, the porosity of the web transition zone can be higher by a factor of at least 1.5, preferably by a factor 2, than the porosity of the web-guiding zone.

Given such a different porosity, the web transition zone and the web-guiding zone can have the same air pressure applied to them, a common compressed air supply preferably being provided. Alternatively or additionally to this, however, it is also possible for the web transition zone or web transition zones, on the one hand, and the web-guiding zone, on the other hand, to have compressed air applied to them at different pressure, in order to bring about a different air throughput. The difference in the application of the compressed air between the web transition zone and the web-guiding zone, that is to say the pressure difference on the inside of the guide surface, can be for example at least 2 bar, in particular at least 4 bar. The different air pressure is preferably produced by at least two separate compressed air supplies.

According to one embodiment of the invention, provision is made for the guide surface to be curved and for the web transition zone—along the direction of movement of the material web and relative to the radius of curvature of the guide surface—to extend over a segment angle of at least +/−5°, preferably between +/−10° and +/−20°, about the geometric point at which the material web runs on and/or off the guide surface. In other words, the relevant web transition zone is restricted with respect to the segment angle to a region in the vicinity of the point at which the material web runs on and/or off the guide surface. In other words, with respect to the segment angle, the relevant web transition zone is restricted to a region in the vicinity of the run-on point or the run-off point, this segment angle relating to the main radius of curvature in the case of a varying curvature. In this embodiment, provision can be made for the web transition zone to extend over an asymmetric segment angle about the geometric run-on point or run-off point, for example by a segment angle of −10°/+5° or of −15°/+20°.

The guide element preferably comprises at least one pressure chamber, via which compressed air can be applied to the porous material. In this case, the porous material can at least partly be applied to a carrier containing the pressure chamber and provided with air passage openings. However, for example, such embodiments in which the porous material forms at least part of the pressure chamber wall are also conceivable. The pressure chamber can supply the web transition zone and the web-guiding zone simultaneously with compressed air, or an individual pressure chamber is provided for each zone.

The pressure in the pressure chamber can in particular be higher than 0.5 bar, preferably being higher than 1 bar.

The specific volume flow in the porous material expediently lies in a range from about 10 to about 5000 Nm³/h·m².

The hole or pore spacing or the distance between the outlet openings in the air-permeable porous material is preferably less than 1 mm.

The porous material is in particular composed in such a way that no individual jets but, instead, a very uniform air cushion is produced, which ensures very good web guidance which, in particular, remains contact-free in any case even in the event of holes, tears or thin strips. In one preferred practical embodiment of the web-guiding device according to the invention, the average size of the outlet openings, pores and/or holes in the porous material is less than 0.2 mm and preferably less than 0.1 mm.

The porous material is preferably chosen such that a high pressure loss from the interior to the surroundings results, which produces a very uniform air cushion.

In an expedient practical embodiment of the web-guiding device according to the invention, the pressure loss, in particular from the side facing away from the moving material web toward the side of the porous material facing the material web, is greater than 0.2 bar and preferably greater than 0.8 bar.

The guide element can be designed in particular as a roll. In this case, this can be designed as a stationary or nonrotating roll or a rotating, preferably driven, roll. In the case of a rotating roll, the different air throughput is preferably brought about by the web transition zone and web-guiding zone, arranged to be stationary and having the same porosity, having a different air pressure applied to them.

In particular in the case in which the guide element is designed as a stationary or nonrotating roll, the air cushion is advantageously produced only on part of the roll circumference.

The roll can have, for example, a diameter in a range from about 50 mm to about 1500 mm.

It is also advantageous in particular if the guide element is designed as a segment of a curve. In this case, it can have a radius of curvature that is constant in the direction of movement of the material web or a radius of curvature that changes in the direction of movement of the material web. In the latter case, the guide element can have a radius of curvature that changes continuously in the direction of movement of the material web or a radius of curvature that changes in discrete steps in this direction of movement.

In order to produce a spreading effect, the guide element or its guide surface can in particular also have a course that is curved in the transverse direction. In this case, the radius of curvature of the guide element or of the guide surface can change over the width extending in the transverse direction.

The radius of curvature of the guide surface expediently lies in a range from about 5 to about 3000 mm.

According to an advantageous development of the invention, the guide surface of the guide element is also subdivided transversely with respect to the direction of movement of the material web into a plurality of zones, which are designed for a different air throughput. For instance, one or two peripheral zones can have a higher air throughput than a central zone of the guide surface, in order to compensate for lateral escape of the compressed air. The different air throughput can be effected by means of different porosities of the zones and/or by applying compressed air to the various zones at a different air pressure.

In a preferred practical embodiment of the web-guiding device according to the invention, the guide element is assembled from a plurality of individual segments in the direction of movement of the material web and/or in the direction transverse hereto. In this case, at least some of the segments can be assigned a common compressed air supply. However, the segments can also be at least partly supplied via separate compressed air supplies.

In a further advantageous embodiment of the web-guiding device according to the invention, the guide surface of the guide element is formed by at least two layers consisting at least partly of air-permeable porous material and preferably having different properties.

In this case, the pressure loss on the inner layer facing away from the material web can be lower than on the outer layer. Alternatively or additionally, the porosity of the inner layer facing away from the material web can be higher or its hole spacing can be greater than in the outer layer. Alternatively or additionally, the hole diameter on the inner layer facing away from the material web can be greater than on the outer layer. It is also advantageous in particular if the layers consist at least partly of different material.

A further preferred embodiment of the web-guiding device according to the invention is distinguished by the fact that the inner layer facing away from the material web consists of air-permeable porous material or is provided with air passage openings only in a subregion and is otherwise air-impermeable, so that an air cushion is produced only in a subregion of the guide element.

The inner layer facing away from the material web can consist at least partly of metal, GRP and/or CRP in particular.

The inner layer facing away from the material web preferably supplies the mechanical loadbearing capacity of the guide element or the guide surface.

The outermost surface of the guide element facing the material web can in particular consist of fine-pore material. It can therefore in particular have a finer level of porosity than the inner layer.

It is also advantageous in particular if the outermost surface of the guide element facing the material web is sintered.

This outermost surface of the guide element facing the material web can consist, for example, of ceramic or sintered ceramic material, in particular of silicate ceramic, oxide ceramic or nitride ceramic material.

The guide surface of the guide element is advantageously provided with air outlet openings preferably produced directly during the production of the outermost surface. The relevant air outlet openings therefore do not have to be introduced into the outermost surface by means of subsequent machining.

As already mentioned, the web-guiding device according to the invention can be used in particular in a machine for the production and/or treatment of a material web, in particular a paper or board web.

Thus, for example, at least one appropriate web-guiding device can be provided after the press section, preferably immediately thereafter. An appropriate web-guiding device can therefore be provided, for example, as a substitute for a conventional paper guide roll after the press, that is to say in a region of a web which is still very wet and sensitive. This is associated with the advantage that the web no longer has to be pulled off and a drive is dispensed with.

It is also advantageous if at least one appropriate web-guiding device is provided in a machine section in which there is an already largely dry material web. The web-guiding device according to the invention can therefore, for example, be provided as a substitute for a conventional paper guide roll in the case of a largely dry web. This is again also associated with the advantage that no drive is required, that is to say it is no longer necessary for all the guide rolls to be driven but only those which are important for the web tension.

Advantageously, at least one appropriate web-guiding device is provided immediately after the last drying cylinder.

In particular, at least one appropriate web-guiding device can also be provided in each case before and/or in a calender. In this case, a respective web-guiding device can again be arranged immediately before or immediately after the calender.

Moreover, for example a use before a winder and/or before an unwind is also conceivable. In this case, the respective web-guiding device can, for example, again be arranged immediately before the winder or unwind.

In principle, at least one appropriate web-guiding device can in each case also be provided in a coating machine and/or in a slitter-rewinder.

It is also advantageous in particular if at least one appropriate web-guiding device is provided after a surface coating means, in particular as a substitute for an airturn. As a result of the small web spacing and the uniform air cushion, crease-free guidance is also ensured here. Further advantages result from the low quantity of air and the smaller overall volume.

In an advantageous practical embodiment, at least one appropriate web-guiding device is provided as a substitute for a respective spreader roll.

Inter alia, is also advantageous if at least one appropriate web-guiding device is provided directly before and/or after an air dryer. In this case, at least one appropriate web-guiding device can in each case be provided, for example, directly before and/or after an impingement dryer in a drying section and/or in a coating machine or afterdryer section.

It is also advantageous in particular if at least one appropriate web-guiding device is provided as a supporting element in a two-row drying group, in the free draw between the cylinders. In this case, of course, appropriate web-guiding devices can also be provided in a plurality of such two-row drying groups.

If the relevant guide element is provided as a rotatably mounted roll, then the result is, moreover, good emergency running properties since, even in the event of failure of the pressure supply, it is not possible for friction to occur between the material web or a moving belt, for example a fabric belt, and the rotating roll.

The guide element can, for example, be wrapped around only by the material web or, in addition to the material web, for example can be wrapped around by at least one fabric belt.

The material web or the moving belt can wrap around the guide element, for example, in accordance with a wrap angle whose range runs from about 5 to about 260°.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 depicts a schematic cross-sectional illustration of guide elements used for non-contact web guidance having a guide surface consisting at least partly of porous material,

FIG. 2 depicts a schematic cross-sectional illustration of further embodiments of the guide element which, for example, are designed in the form of a segment of a curve,

FIG. 3 depicts a schematic cross-sectional illustration of guide elements used for non-contact web guidance having a guide surface consisting at least partly of porous material,

FIG. 4 depicts a schematic cross-sectional illustration of further embodiments of the guide element which, for example, are designed in the form of a segment of a curve,

FIG. 5 depicts a schematic longitudinal sectional illustration of a further embodiment of the guide element which is subdivided in the transverse direction into at least two zones or segments, the various segments having the same pressure applied to them in the present case,

FIG. 6 depicts an embodiment of the guide element comparable with the embodiment according to FIG. 5 but the various segments having a different pressure applied to them in the present case,

FIG. 7 depicts a schematic illustration of a guide element that his bent in the transverse direction and, for example, can be used for spreading, and

FIG. 8 depicts a schematic illustration of a preferred embodiment in which a guide element is provided after an applicator as a substitute for an airturn.

### DETAILED DESCRIPTION OF THE PRESENT INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

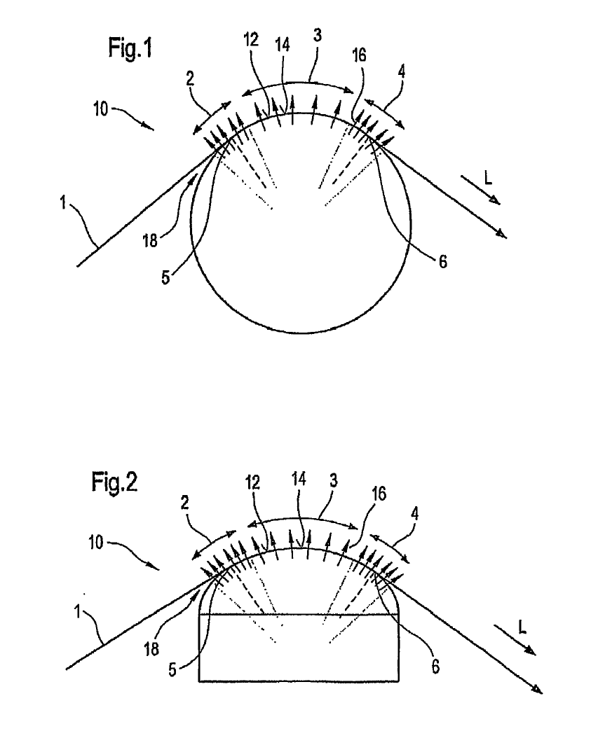

FIG. 1 shows, in a schematic cross-sectional illustration along the direction of movement L of a material web 1, an embodiment of a guide element 10 of a web-guiding device used for non-contact web guidance, which in particular can be used in a machine which is used for the production and/or treatment of a material web, for example a paper or board web. Such a guide element 10 can in particular be provided after an applicator as a substitute for an airturn (cf. also FIG. 8).

The guide element 10, designed in the present case in the form of a roll, for example, has a guide surface 12 which consists of air-permeable porous material 14, to which compressed air can be applied from the inside in order to form an air cushion 18 via the air 16 flowing through the porous material 14 and the moving material web 1.

The guide surface 12 of the guide element 10 is subdivided along the direction of movement L of the material web 1 into a first web transition zone, specifically a web run-on zone 2, furthermore into a web-guiding zone 3 which follows the former and, following the latter, into a second web transition zone, namely a web runoff zone 4. The web run-on zone 2 and the web run-off zone 4 of the guide surface 12 are designed for a higher throughput of the air 16 flowing through than the web-guiding zone 3 arranged between them, as is indicated in FIG. 1 by the density of the arrows which symbolize the air 16 flowing through.

In particular in the case in which the guide element 10 shown is designed as a stationary roll, the different air throughput is brought about by means of a different porosity of the porous material 14 in the different zones 2, 3, 4. On the other hand, if the guide element 10 is designed as a rotating roll, then the different air throughput is effected, for example, by the rotating roll shell having a uniform porosity but the application of compressed air at different intensities being carried out within the different zones 2, 3, 4. Otherwise—in particular in the case of a guide element 10 arranged to be stationary—a different air throughput in the different zones 2, 3, 4 can also be effected by a combination of different porosities in the zones 2, 3, 4 of the guide surface 12 with a different application of air pressure along the different zones 2, 3, 4.

The web run-on zone 2 extends on the guide surface 12 along a segment angle of a total of 20° symmetrically about the geometric point 5 at which the material web 1 runs on, that is to say about that point at which the material web 1 contacts the guide surface 12 tangentially. The web run-off zone 4 extends on the guide surface 12 along a segment angle of 20° symmetrically about the geometric point at which the material web 1 runs off, i.e. at which the material web 1 is separated from the curved guide surface 12 in the tangential direction. Outside the web run-on zone 2, the web-guiding zone 3 and the web run-off zone 4, compressed air does not flow through the guide element 10.

By means of the air cushion 18, the material web is guided without contact at a short distance from the guide surface 12. The construction of the guide surface 12 with the porous material 14 in this case ensures a particularly uniform build-up of the air cushion 18, so that a fault-free and crease-free run of the material web 1 is effected.

The higher air throughput in the web run-on zone 2 and the web run-off zone 4 has the effect that, in the vicinity of the run-on point 5 and of the run-off point 6, there is no undesired pressure drop at the surface of the guide element 10. Thus, even in these regions of the guide element 10, non-contact guidance of the material web 1 is ensured without an unnecessarily high consumption of compressed air having to be accepted for this purpose along the entire guide surface 12 and in particular within the web-guiding zone 3.

For this purpose, it is possible, for example, for the web run-on zone 2 and the web run-off zone 4 to have a porosity higher by a factor of 1.5 than the web-guiding zone 3, and/or for the application of compressed air to the web run-on zone 2 and the web run-off zone 4 on the inside of the guide surface 12 to be higher than along the web-guiding zone 3.

Otherwise, it is also possible, within the web run-on zone 2, for the air throughput to rise continuously counter to the direction of movement L of the material web 1, and/or, within the web run-off zone 4, for the air throughput to rise continuously in the direction of movement L of the material web 1, in order to effect a gradual transition to the air throughput provided within the web-guiding zone 3. Furthermore, the different air throughput in the zones 2, 3, 4 can also be varied over time, in particular by means of a corresponding variation in the application of compressed air.

FIG. 2 shows a guide element 10 comparable with the embodiment according to FIG. 1, whose guide surface 12 is likewise subdivided into a web run-on zone 2, a web-guiding zone 3 following the former and a web run-off zone 4 following the latter. The physical position of these zones 2, 3, 4 is permanently predefined by means of a different porosity of the guide surface 12. On account of the different porosity, a single, compressed air supply in the interior of the guide element 10 is sufficient to bring about a different air throughput in the web run-on zone 2 and the web run-off zone 4 and along the web-guiding zone 3.

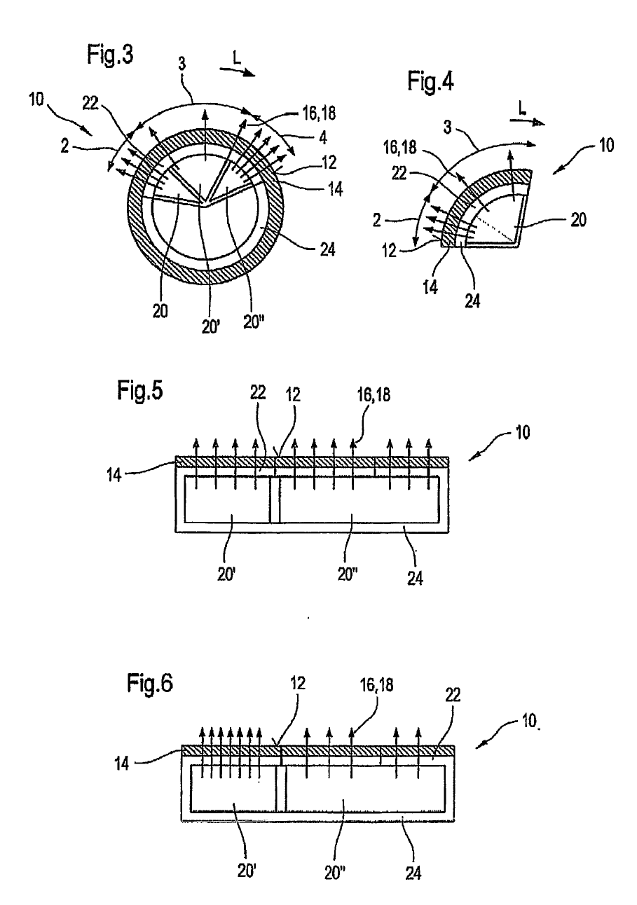

FIG. 3 shows a further embodiment of a guide element 10 of a web-guiding device used for non-contact web guidance, in a schematic illustration. This guide element 10 is designed in the form of a rotating roll. The guide element 10 has a guide surface 12 which consists of an air-permeable porous material 14, to which compressed air can be applied from the inside, in order to form an air cushion 18 between the guide surface 12 and the moving material web 1 via the air 16 flowing through the porous material 14.

In the interior, the guide element 10 has three pressure chambers 20, 20′, 20″ arranged to be stationary, via which compressed air at different pressure can be applied to the porous material 14. In this way, the guide surface 12 is subdivided into three stationary zones with different air throughputs, namely into a web run-on zone 2, a web-guiding zone 3 and a web run-off zone 4.

As illustrated, the guide element 10 can comprise a carrier 24 containing the pressure chambers 20, 20′, 20″ and provided with at least one and preferably a plurality of air passage openings 22, to which carrier the porous material 14 is applied. In the present case, this carrier 24, which is roll-like here, for example, is completely surrounded in the circumferential direction by porous material 14.

As an alternative to the configuration as a rotating roll, the guide element 10 according to FIG. 3 can also be constructed as a stationary roll having three pressure chambers 20, 20′, 20″, the pressure chambers 20, 20′, 20″ and the air passage openings 22 in the carrier 24 being provided only along part of the circumference of the guide element 10, so that the air cushion is also produced only along part of the circumference. The air cushion 18 is expediently produced at least in the region in which the material web 1 wraps around the guide element 10.

On account of the roll-like design, the guide element 10 has a radius of curvature in the direction of movement L, in particular also in the wrap region.

FIG. 4 shows a further embodiment of the guide element 10, which is designed here in the form of a segment of a curve, by way of example, in a schematic cross-sectional illustration. Via a single pressure chamber 20, compressed air is again applied to the relevant segment, so that air 16 flows through the porous material 14 from inside to outside. In the present case, too, the porous material 14 is again applied to the outside of a carrier 24 containing the pressure chamber 20. The wall of the carrier 24 or of the pressure chamber 20 is again provided with air passage openings 22, via which compressed air is applied to the porous material 14 from inside. The porosity of the porous material 14, and thus the respective air throughput, is higher in a web run-on zone 2 than along a web-guiding zone 3.

As can be seen from FIG. 4, in the present case the guide element 10 or its guide surface 12 is also again curved in the machine running direction or direction of movement L. Just as in the embodiment according to FIG. 3, here, too, the radius of curvature is, for example, also constant over the wrap region.

FIG. 5 shows a further embodiment of the guide element 10 in a schematic longitudinal sectional illustration, that is to say transversely with respect to the direction of movement of the material web. In this case, the guide element 10 or its pressure chamber is subdivided in the transverse direction into at least two segments 20′, 20″, via which compressed air can be applied, possibly separately, to the porous material 14 in the transverse direction. In the phase reproduced in FIG. 5, the zones 20′, 20″ have the same pressure applied to them, at least to some extent. On the other hand, FIG. 6 shows the same guide element 10 in a phase in which the zones or segments 20′, 20″ are currently having different pressure applied to them.

The pressure can therefore be varied across the width, that is to say in the transverse direction, in the desired manner, depending on the respective requirements. Otherwise, the guide element 10 can at least substantially again have a construction such as has been described in connection with the other embodiments.

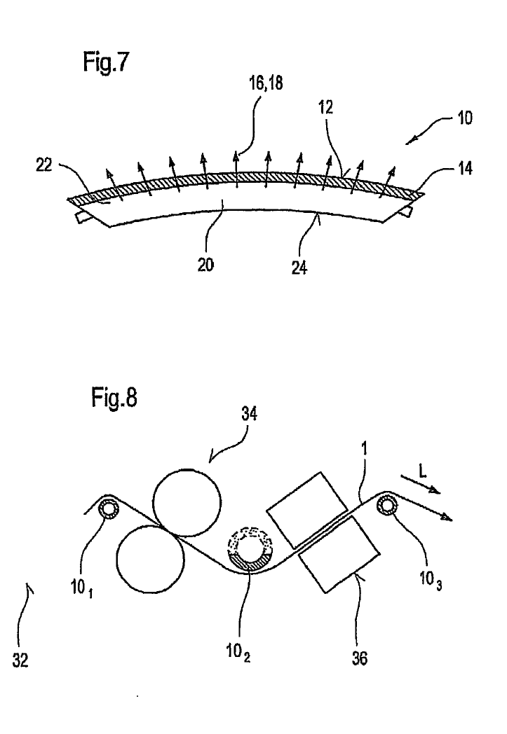

FIG. 7 shows a schematic illustration of a guide element 10 curved in the transverse direction and capable of use, for example, for spreading. The guide element again has a carrier 24 having at least one pressure chamber 20, to which the porous material 14 is applied and via whose pressure chamber 20 compressed air is applied to the porous material 14 from inside. With appropriate rotation of the guide element 10, for example the effective bending radius can be changed. Otherwise, this embodiment again has, at least substantially, the same construction as the embodiments previously described.

Whereas, in the exemplary embodiments according to FIGS. 3 to 7, the porous material 14 is in each case applied to a carrier 24 provided with air passage openings 22, in principle at least part of a carrier wall or least part of the pressure chamber 20 can also be formed by the porous material 14.

In the illustration according to FIG. 8, a guide element 101 is arranged after the drying section 32 and before an applicator unit 34, a guide element 102 is arranged as a substitute for an airturn between the applicator unit 34 and, for example, an impingement dryer 36, and a guide element 103 is arranged after the impingement dryer 36. The guide elements 10 can in particular again be designed in such a way as has previously been described, for example by using FIGS. 1 to 7. It is also possible, for example, for at least one guide element 10 to be provided in a coating machine, before a winder and/or after an unwind.

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present extends to all functionally equivalent structures, methods and uses, such as are within the scope of the appended claims.

List of designations

| | |
|---|---|
| 1 | Material web |
| 2 | Web run-on zone |
| 3 | Web-guiding zone |
| 4 | Web run-off zone |
| 5 | Geometric run-on point |
| 6 | Geometric run-off point |
| 10 | Guide element |
| 12 | Guide surface |
| 14 | Porous material |
| 16 | Air flowing through |
| 18 | Air cushion |
| 20 | Pressure chamber |
| 22 | Air passage opening |
| 24 | Carrier |
| 32 | Drying section |
| 34 | Applicator unit |
| 36 | Impingement dryer |
| L | Direction of movement of the material web |

1-35. (canceled)

36. A web-guiding device comprising:
at least one guide element for non-contact web guidance;
wherein the guide element has a guide surface, the guide surface comprising an air-permeable porous material to which compressed air is applied;
whereby air flowing through the porous material forms an air cushion between the guide surface and a material web; and
wherein the guide surface is divided along the direction of movement (L) of the material web into at least one web transition zone and a web-guiding zone.

37. The web-guiding device of claim 36, wherein the at least one web transition zone has a higher air throughput than the web-guiding zone.

38. The web-guiding device of claim 36, wherein the web transition zone is one of a web run-on zone and a web run-off zone.

39. The web-guiding device of claim 36, wherein the guide surface has two web transition zones between which, with respect to the direction of movement (L) of the material web, the web-guiding zone is arranged.

40. The web-guiding device of claim 39, wherein the two web transition zones are a web run-on zone and a web run-off zone, and wherein the web run-on zone and the web run-off zone have a different air throughput.

41. The web-guiding device of claim 36, wherein porosity of the at least one web transition zone and porosity of the web-guiding zone are different.

42. The web-guiding device of claim 41, wherein the porosity of the at least one web transition zone is higher than the porosity of the web-guiding zone.

43. The web-guiding device of claim 42, wherein the porosity of the at least one web transition zone is higher than the porosity of the web-guiding zone by a factor of at least one of at least 1.5 and at least 2.

44. The web-guiding device of claim 36, wherein the at least one web transition zone and the web-guiding zone have compressed air applied to them at one of the same pressure and a different pressure.

45. The web-guiding device of claim 44, wherein when different pressure is applied, the pressure difference is one of at least 2 bar and at least 4 bar.

46. The web-guiding device of claim 44, wherein the at least one web transition zone has compressed air applied to it at a higher pressure than the web-guiding zone.

47. The web-guiding device of claim 36, wherein the guide surface is curved and wherein the at least one web transition zone extends along the direction of movement (L) of the material web, with respect to the radius of curvature of the guide surface, by a segment angle of at least one of at least +/−5°, and between +/−10° and +/−20°, about the geometric point at which the material web runs one of on and off the guide surface.

48. The web-guiding device of claim 47, wherein the at least one web transition zone extends by an asymmetric segment angle about the geometric point at which the material web runs one of on and off the guide surface.

49. The web-guiding device of claim 36, the guide element further comprising at least one pressure chamber via which compressed air can be applied to the porous material.

50. The web-guiding device of claim 49, wherein the porous material is applied at least partly to a carrier containing the pressure chamber and provided with air passage openings.

51. The web-guiding device of claim 49, wherein the porous material forms at least part of a pressure chamber wall.

52. The web-guiding device of claim 36, wherein pressure in an interior of the guide element is at least one of higher than 0.5 bar and higher than 1 bar.

53. The web-guiding device of claim 36, wherein specific volume flow in the porous material is between 10 and 5000 Nm³/h·m².

54. The web-guiding device of claim 36, wherein pore spacing of the air-permeable porous material is less than 1 mm.

55. The web-guiding device of claim 36, wherein average size of pores of the porous material is one of less than 0.2 mm and less than 0.1 mm.

56. The web-guiding device of claim 36, wherein pressure loss from a side facing away from the moving material web toward a side of the porous material facing the material web is one of greater than 0.2 bar and greater than 0.8 bar.

57. The web-guiding device of claim 36, wherein the guide element is a roll.

58. The web-guiding device of claim 57, wherein the guide element is one of a stationary roll and a nonrotating roll.

59. The web-guiding device of claim 57, wherein the air cushion is produced only on part of a circumference of the roll.

60. The web-guiding device of claim 57, wherein the guide element is one of a rotating roll and a driven roll.

61. The web-guiding device of claim 36, wherein the guide element is a segment of a curve.

62. The web-guiding device of claim 36, wherein one of the guide element and the guide surface has a course curved in a transverse direction.

63. The web-guiding device of claim 36, wherein the guide surface is subdivided transversely with respect to the direction of movement (L) of the material web into a plurality of zones, the zones designed for a different air throughput.

64. The web-guiding device of claim 36, the guide element further comprising at least two segments, the segments at least one of along and transversely with respect to the direction of movement (L) of the material web.

65. The web-guiding device of claim 36, wherein the guide surface of the guide element comprises at least two layers, each layer consisting at least partly of air-permeable porous material.

66. The web-guiding device of claim 36, wherein the surface of the guide element facing the material web is sintered.

67. The web-guiding device of claim 36, wherein the surface of the guide element facing the material web comprises ceramic material.

68. A machine for at least one of production of a material web and treatment of a material web, comprising at least one web-guiding device, the web-guiding device comprising:
at least one guide element for non-contact web guidance;
wherein the guide element has a guide surface, the guide surface comprising an air-permeable porous material to which compressed air is applied;
whereby air flowing through the porous material forms an air cushion between the guide surface and a material web; and
wherein the guide surface is divided along the direction of movement (L) of the material web into at least one web transition zone and a web-guiding zone.

69. The machine of claim 68, wherein the guide element is wrapped around by the material web.

70. The machine of claim 68, wherein the guide element is wrapped around by the material web and by at least one of a moving belt and a fabric belt.
